(19) United States
(12) Patent Application Publication
(10) Pub. No.: US 2013/0117583 A1
(43) Pub. Date: May 9, 2013

(54) METHOD FOR MANAGING THE SUPPLY VOLTAGE OF A MICROCONTROLLER FOR AN ELECTRONIC COMPUTER OF A MOTOR VEHICLE

(71) Applicants: Frédéric Le-Hung, Tournefeuille (FR); Stéphane Saint-Macary, Toulouse (FR)

(72) Inventors: Frédéric Le-Hung, Tournefeuille (FR); Stéphane Saint-Macary, Toulouse (FR)

(73) Assignees: CONTINENTAL AUTOMOTIVE GMBH, Hannover (DE); CONTINENTAL AUTOMOTIVE FRANCE, Toulouse (FR)

(21) Appl. No.: 13/702,436

(22) PCT Filed: Jun. 14, 2011
(86) PCT No.: PCT/EP2011/002930

§ 371 Date: Jan. 16, 2013

(30) Foreign Application Priority Data
Jun. 24, 2010 (FR) 1002640

(51) Int. Cl. G06F 1/26

(52) U.S. Cl. CPC G06F 1/26
USPC 713/300

(57) ABSTRACT

A method for managing the power supply voltage (Vₛ) of an electronic computer of a motor vehicle, the electronic computer including: a microcontroller, a power supply circuit powered by a battery and supplying the microcontroller with a power supply voltage regulated by a regulator having a nominal regulation frequency (F_{REF}) set by a clock, at least one electronic component connected to the microcontroller and the power supply circuit which supplies it with a regulated power supply voltage, a element of communication between the microcontroller and the power supply circuit, the method includes:
identification of an imminent modification of the current demand,
sending an instruction to increase the F_{REF},
increasing its F_{REF} to a higher regulation frequency (F_{ACCEL}), for a predetermined time period (T) measured by the internal clock,
when T has elapsed, lowering the higher regulation frequency (F_{ACCEL}) to its nominal regulation frequency (F_{REF}).

The present invention relates to a method for managing the power supply voltage of an electronic computer of a motor vehicle.

At present, the electronic computers installed in motor vehicles comprise a power supply circuit connected to the battery of the vehicle and managing the power supply voltage delivered to the various electronic components contained in the electronic calculator as well as to the microcontroller.

The purpose of the power supply circuit is to supply a regulated and stable power supply voltage to the components irrespective of the fluctuations of the voltage of the battery and irrespective of the current demands coming from the microcontroller and from the electronic components.

In fact, it will be understood that if the voltage of the battery fluctuates, for example when it drops on starting the engine, the voltage that the battery delivers to the power supply circuit of the electronic computer also drops. The power supply circuit of the computer must then be adapted and compensated for this drop in order to maintain a stable power supply voltage for the microcontroller and for the components in order not to have an impact on their operation.

Conversely, if the current demand from the microcontroller and/or the components of the power supply circuit is suddenly higher (for example by switching on a component such as the air conditioning of the vehicle), the power supply circuit must then be adapted to this rise in current demand. In the case of a so-called “chopping” power supply circuit, the power supply circuit regulates the power supply voltage according to a load and unload frequency which is intrinsic to its chopping circuit. The chopping consists in accumulating energy and transferring it to the load whilst interrupting the consumption of electrical current in a cyclic manner. The operating frequency of a chopping power supply is predetermined and is not always suitable for very fast transient phases of high demand for or of large drop in the current coming from the microcontroller and/or the components. Increasing this regulating frequency of the power supply voltage permanently is not possible without risk of overheating the power supply circuit.

Up until the present time, in order to overcome this problem, the regulation of the power supply voltage to the microcontroller and to the components has been carried out using capacitors having a high value of capacitance (50 μF) on the power supply voltage line between the power supply circuit on the one hand and the microcontroller and the electronic components on the other hand. These capacitors make it possible to stabilize the electrical power supply during large variations in the current demand. They are generally oversized in order to be able to stabilize the voltage even in the extreme cases of large variations in current demand. This is known to those skilled in the art and will not be described in greater detail here.

The disadvantage of this solution is its significant cost due to the oversizing of electronic components (in this case the capacitors). Moreover, the adaptation time of the power supply circuit is not optimized, since it only reacts to the modification in current demand once this has taken place. The result of this is that, during transition phases, the power supply circuit supplies, for a few moments (the time necessary for the capacitors to regulate the voltage), a power supply voltage which is not stable and whose value fluctuates according to the transient phase of the capacitors used.

It is this disadvantage that the present invention proposes to overcome.

The invention proposes a method for managing the power supply voltage of an electronic computer of a motor vehicle, not necessitating capacitors having a high value of capacitance, and reacting faster to current demand variations than does the device of the prior art. In this instance, the invention is based on the fact that the information on imminent variations in current demand, due to the switching on or off of electronic components managed by the microcontroller, is an item of information available in the microcontroller itself. This makes it possible to anticipate these variations and to adapt the power supply voltage faster during the transient phases of variation in current demand.

The objectives of the invention are achieved by means of a method for managing the power supply voltage of an electronic computer of a motor vehicle, the electronic computer comprising:
a microcontroller,
a power supply circuit, powered by a voltage coming from the battery and supplying the microcontroller with a power supply voltage regulated by a regulator having a nominal regulation frequency set by a clock,
at least one electronic component, connected to the microcontroller and connected to the power supply circuit which supplies it with a regulated power supply voltage,
a means of communication between the microcontroller and the power supply circuit,
   characterized in that said method comprises the following steps:
identification by the microcontroller of an imminent modification of the current demand coming from the at least one electronic component,
sending by the microcontroller to the power supply circuit, by the intermediary of the communication means, of an instruction to increase the nominal regulation frequency of the power supply circuit,
increasing, by the power supply circuit, of its nominal regulation frequency to a higher regulation frequency, for a predetermined time period measured by the internal clock of the power supply circuit,
when the predetermined time period has elapsed, lowering, by the power supply circuit, of the higher regulation frequency to its nominal regulation frequency.

In a first embodiment of the invention, the nominal regulation frequency is a signal whose pulse width is modulated and the increase of this frequency is carried out by modifying the shape of this signal.

In another embodiment, the regulator is a Proportional Integral Derivative regulator and the increase of the regulation frequency of the power supply circuit is carried out by modifying the values of the parameters of this regulator.

A third embodiment combines the two preceding embodiments.

Advantageously, the invention proposes that the predetermined time period is representative of the typical average time period of the transient phases of modification of the current demand or is a function of the instruction to increase the nominal regulation frequency of the power supply circuit.

Finally, the invention also relates to any electronic computer of a motor vehicle implementing the method described above.

Other purposes, features and advantages of the invention will become apparent on reading the following description, given by way of non-limiting example and on examination of the appended drawings in which:

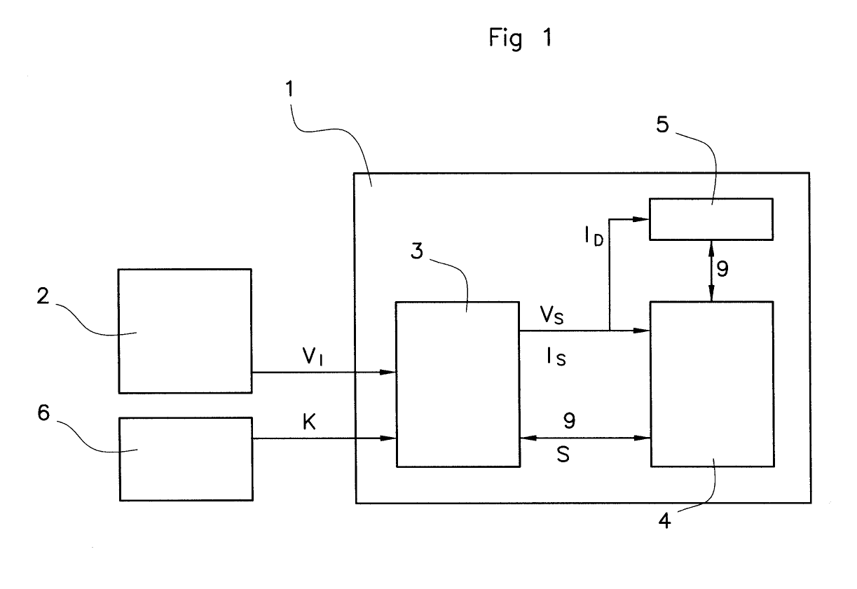

FIG. 1 is a block diagram of a device for managing the power supply voltage of an electronic computer of a motor vehicle according to the invention,

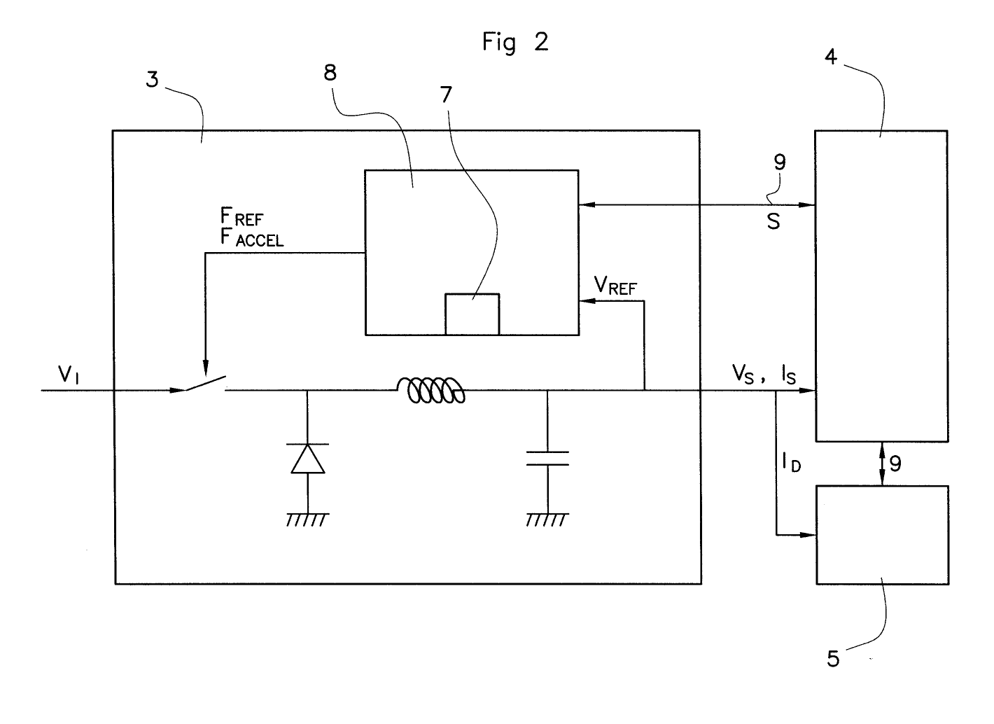

FIG. 2 is a detailed circuit diagram of an electronic computer according to the invention,

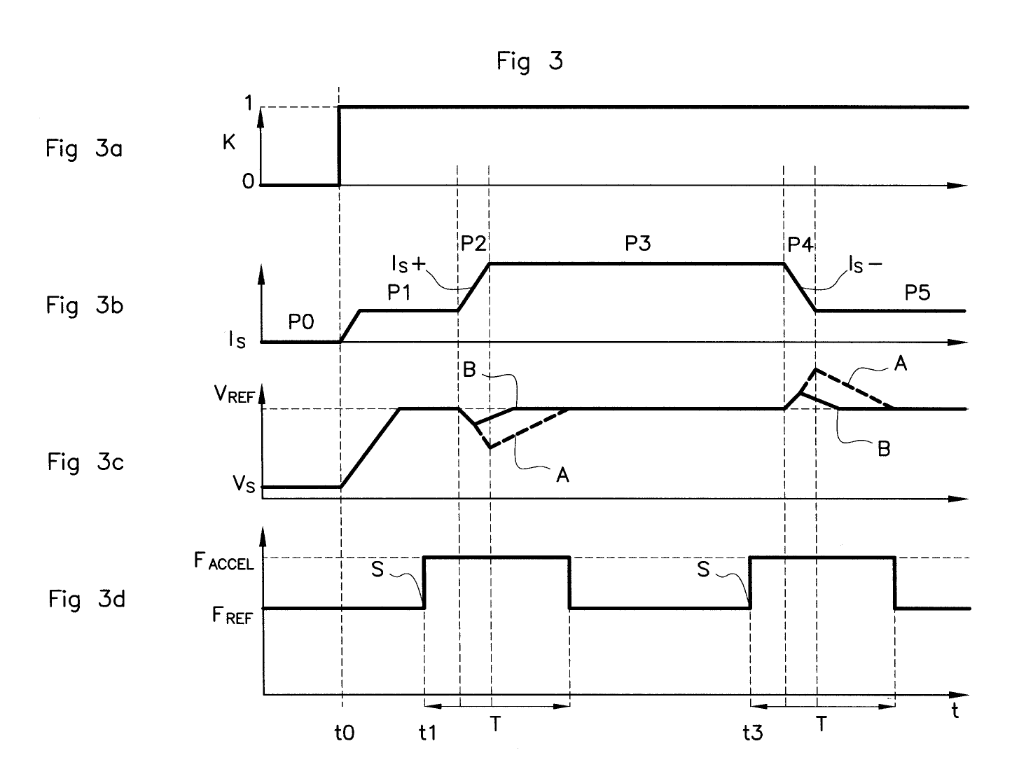

FIG. 3 is a graphical representation of the method for managing the power supply voltage according to the invention.

The device for managing the power supply voltage of an electronic computer 1 of a motor vehicle (not shown) is shown in FIG. 1. The electronic computer 1 comprises a microcontroller 4, connected to one or more electronic components 5 by a means of communication 9.

The microcontroller 4 manages the operation of these components 5. It is supplied with voltage and current by a power supply circuit 3 which supplies it with a power supply voltage and current, Vₛ and Iₛ respectively, which it uses for its own operation. The components 5 are also connected to the power supply circuit 3 and are supplied with the same voltage and the same current, Vₛ and Iₛ.

The power supply circuit 3 is itself supplied with current by the battery 2 of the vehicle which provides it with a voltage V_{I}. The switching on of this power supply circuit 3 depends on the state of the vehicle and in particular on the state of the ignition key 6 which sends a signal K when it is engaged, that is to say when the user starts his vehicle or simply makes the contact, which powers up the electronic computer 1.

The power supply circuit 3 is shown in FIG. 2. It has a nominal regulation frequency F_{REF} of the power supply voltage Vₛ which is for example a signal of the PWM (Pulse Width Modulation) type controlled by a clock 7 and regulated by a “Proportional Integral Derivative” regulator, called a PID regulator 8, or regulated by a regulator.

The microcontroller 4 and the power supply circuit 3 are connected by a serial communication link of the bus type 9, necessary for diagnostics or for the configuration of the power supply. This communication bus 9 makes it possible to maintain the microcontroller 4 under power for a few moments after the vehicle has stopped in order to carry out various operations, for example keeping the engine's cooling fan running when the engine has stopped.

According to the invention, when the microcontroller 4 detects an imminent modification of the current demand I_{D} coming from one of the components 5, for example when it detects that a switching on or off of the air conditioning has been carried out by the user (by pressing a start/stop button on the dashboard of the vehicle), the microcontroller 4 sends, over the communication bus 9, and even before the air conditioning has started or stopped, an instruction S to the power supply circuit 3 requesting an increase in its regulation frequency F_{REF}. It does this in order to adapt the power supply voltage Vₛ more quickly to this increase or decrease in the current demand Iₛ. It should be noted that this detection of an imminent current demand carried out by the microcontroller 4 and coming from the components 5 is possible because the microcontroller 4 manages the operation of these components 5 and it is therefore connected to the components by the communication means 9 but it is also connected to all the interfaces (not shown) such as the switch-on buttons actuating their operation.

The latency time between the switch on or switch off of a component 5 request made by the user and the actual switching on or switching off of the component, which is of the order of about ten to a hundred milliseconds, is very much greater than the time necessary for the microcontroller 4 to send the instruction S to the power supply circuit 3. The latter can therefore anticipate the modification in the current demand Iₛ and modify its regulation frequency F_{REF} in order to regulate the power supply voltage Vₛ to its nominal value V_{REF} more quickly.

Thus, when the component is switched on, that is to say at the time of the actual modification of the current demand Iₛ, the power supply circuit 3 is already operating at a higher regulation frequency F_{ACCEL} and adapts the power supply voltage Vₛ more rapidly to its nominal value V_{REF}.

The method for managing the power supply voltage according to the invention is illustrated by a graphical representation in FIG. 3.

In this FIG. 3, the following are shown as a function of time t:
in FIG. 3a, the state K of the ignition key 6, 0 corresponding to the key not engaged and 1 corresponding to the key engaged,
in FIG. 3b, the current demand Iₛ coming from the microcontroller 4 and the components 5,
in FIG. 3c, the voltage Vₛ coming from the power supply circuit 3 according to the modification in the current demand Iₛ,
in FIG. 3d, the different regulation frequencies F_{REF} and F_{ACCEL} of the power supply voltage used by the power supply circuit 3 according to the different phases P0, P1, P2, P3, P4 and P5 defined according to the values and modifications of the current demand Iₛ.

When the ignition key 6 is engaged, (position 1 in FIG. 3a), the electronic computer 1 is powered with a current Iₛ and a voltage Vₛ =V_{REF} (cf. FIGS. 3b and 3c). This phase corresponds to phase P1 in FIG. 3b.

During this phase P1, the power supply circuit 3 regulates the voltage Vₛ at its nominal value V_{REF} at a regulation frequency equal to its nominal frequency F_{REF}.

When there is a sudden increase in current Iₛ+ coming from the microcontroller and/or the components 5 (cf. FIG. 3b), during the phase P2, according to the prior art, the voltage Vₛ delivered by the power supply circuit 3 drops suddenly (cf. dotted line A in FIG. 3c). According to the invention, the power supply circuit 3 which has previously received the instruction S at the time t1 has already increased its regulation frequency F_{REF} to a higher frequency F_{ACCEL} (cf. FIG. 3d) in order to adapt the power supply voltage Vₛ more quickly to this rise in current demand Iₛ+. Thus, the transient drop in the power supply voltage Vₛ is much smaller in amplitude and in duration (cf. continuous line B in FIG. 3c) than with the device of the prior art.

The use of a higher regulation frequency F_{ACCEL} by the power supply circuit 3 is carried out for a predetermined time period T. Once this predetermined time period T has elapsed, the power supply circuit 3 returns to its nominal regulation frequency F_{REF} during the phase P3 of stabilization of the current demand. The predetermined time period T is, for example, representative of the typical average time period of the transient phases of modification of the current demand Iₛ and should not exceed a few milliseconds in order not to overheat the power supply circuit 3. It can also vary and be dependent on the instruction S sent by the microcontroller 4.

The phase P4 represents the case where a current drop Iₛ− occurs. In the same way, the method according to the invention makes it possible to increase, from the time t3 (as soon as the instruction S has been sent to the power supply circuit before phase P4) and for a predetermined time period T, the regulation frequency F_{REF} of the power supply circuit 3 to a frequency F_{ACCEL} and thus to reduce in amplitude and duration the rise in the voltage Vₛ provoked by this drop in current demand (cf. continuous line B and dotted line A in FIG. 3c).

The sending of an instruction S from the microcontroller 4 to the power supply circuit 3 and the changes in regulation frequency of the power supply circuit 3 are carried out by the programming of the software contained in the microcontroller 4 and in the power supply circuit 3 without the addition of electronic components. The changing of the regulation frequency F_{REF} of the power supply circuit 3 is carried out by modifying the PWM frequency signal and/or by modifying the parameters of the PID regulator. The predetermined time period T of using the high frequency F_{ACCEL} is determined by using the clock 7 already existent in the power supply circuit 3, connected to the PID controller 8 and which sets the timing of the PWM signal.

In comparison with the prior art, the invention thus makes it possible to reduce in amplitude and in duration the fluctuations of the power supply voltage Vₛ supplied to the microcontroller 4 and to the components during transient phases of modification of the current demand Iₛ. The invention furthermore has the advantage of having a low cost as it can be produced simply by programming the software and makes it possible to reduce significantly the value of the capacitance of the capacitors of the prior art.

The invention is not of course limited to the described and shown embodiment which has been given only by way of example. The invention is not limited to the regulation of the voltage supplied to a microcontroller and to the components whose operation it manages and is, of course, applicable to the regulation of the voltage supplied to any so-called “intelligent” component (sensor, actuator), that is to say an electronic component which has the ability to send an instruction to the power supply circuit warning it of an imminent variation of the current demand due to its switching on or switching off. In this respect it can be applied to so-called “SMART” electronic components.

1. A method for managing the power supply voltage (V_{S}) of an electronic computer (1) of a motor vehicle, the electronic computer (1) comprising:
a microcontroller (4),
a power supply circuit (3), powered by a voltage (V₁) coming from a battery (2) and supplying the microcontroller (4) with a power supply voltage (Vₛ) regulated by a regulator (8) having a nominal regulation frequency (F_{REF}) set by a clock (7),
at least one electronic component (5), connected to the microcontroller (4) and connected to the power supply circuit (3) which supplies it with a regulated power supply voltage (Vₛ),
a means (9) of communication between the microcontroller (4) and the power supply circuit (3),
characterized in that said method comprises the following steps:
identification by the microcontroller (4) of an imminent modification of the current demand (I_{D}) coming from the at least one electronic component (5),
sending by the microcontroller (4) to the power supply circuit (3), by the intermediary of the communication means (9), of an instruction (S) to increase the nominal regulation frequency (F_{REF}) of the power supply circuit (3),
increasing, by the power supply circuit (3), of its nominal regulation frequency (F_{REF}) to a higher regulation frequency (F_{ACCEL}), for a predetermined time period (T) measured by the internal clock (7) of the power supply circuit (3),
when the predetermined time period (T) has elapsed, lowering, by the power supply circuit (3), of the higher regulation frequency (F_{ACCEL}) to its nominal regulation frequency (F_{REF}).

2. The management method as claimed in claim 1, characterized in that the nominal regulation frequency (F_{REF}) is a pulse width modulation (PWM) signal and that the increase of this frequency is carried out by modifying the characteristics of this signal.

3. The management method as claimed in claim 1, characterized in that the regulator (8) is a Proportional Integral Derivative regulator (8) and that the increase of the regulation frequency (F_{REF}) of the power supply circuit (3) is carried out by modifying the values of the parameters of this PID regulator (8).

4. The management method as claimed in claim 1, characterized in that the predetermined time period (T) is representative of the average time period of the transient phases of modification of the current demand (Iₛ).

5. The management method as claimed in claim 1, characterized in that the predetermined time period (T) is a function of the instruction (S) to increase the nominal regulation frequency (F_{REF}) of the power supply circuit (3).

6. An electronic computer (1) of a motor vehicle implementing the method as claimed in claim 1.

7. The management method as claimed in claim 2, characterized in that the regulator (8) is a Proportional Integral Derivative regulator (8) and that the increase of the regulation frequency (F_{REF}) of the power supply circuit (3) is carried out by modifying the values of the parameters of this PID regulator (8).

8. The management method as claimed in claim 2, characterized in that the predetermined time period (T) is representative of the average time period of the transient phases of modification of the current demand (Iₛ).

9. The management method as claimed in claim 2, characterized in that the predetermined time period (T) is a function of the instruction (S) to increase the nominal regulation frequency (F_{REF}) of the power supply circuit (3).

10. The management method as claimed in claim 3, characterized in that the predetermined time period (T) is representative of the average time period of the transient phases of modification of the current demand (Iₛ).

11. The management method as claimed in claim 3, characterized in that the predetermined time period (T) is a function of the instruction (S) to increase the nominal regulation frequency (F_{REF}) of the power supply circuit (3).

12. The management method as claimed in claim 4, characterized in that the predetermined time period (T) is a function of the instruction (S) to increase the nominal regulation frequency (F_{REF}) of the power supply circuit (3).
